(19) United States
(12) Patent Application Publication
(10) Pub. No.: US 2007/0263898 A1
(43) Pub. Date: Nov. 15, 2007

(54) Method of Concealing an Image

(76) Inventors: Lawrence David McCarthy, Victoria (AU); Gerhard Frederick Swiegers, Victoria (AU)

Correspondence Address: LADAS & PARRY, 5670 WILSHIRE BOULEVARD, SUITE 2100, LOS ANGELES, CA, 90036-5679, US

(21) Appl. No.: 10/586,211

(22) PCT Filed: Jan. 14, 2005
(86) PCT No.: PCT/AU05/00034

§ 371 Date: Feb. 15, 2007

(30) Foreign Application Priority Data
Jan. 15, 2004 (AU) 2004900187

(51) Int. Cl. G06T 1/00

(52) U.S. Cl. 382/100

(57) ABSTRACT

There is disclosed a method of forming a security image from two or more images comprising manipulating tonal values of each image element of a first image to take values within a first set of tonal values, manipulating tonal values of each image element of a second image to take values within a second set of tonal values, and forming a security image (20) from the manipulated tonal values of the first and second images, the first and second sets of tonal values being selected so that at least one of the first and second images is concealed in the security image.

### FIELD OF THE INVENTION

The present invention relates to a method of creating a security image in which at least one image is concealed. In one embodiment an encoded image is concealed within a visible image. Embodiments of the invention have application in the provision of security devices which can be used to verify the legitimacy and presence of a document or instrument, for example a credit card. Other embodiments can be used to provide novelty items which are protected against counterfeiting.

### BACKGROUND TO THE INVENTION

In order to authenticate and verify the originality of, and to prevent unauthorised duplication or alteration of documents such as banknotes, credit cards and the like, security devices are often incorporated. The security devices are designed to provide some proof of authenticity and deter copying. Despite the wide variety of techniques which are available, there is always a need for further techniques which can be applied to provide a security device.

A variety of techniques have been developed to conceal latent images within security documents and instruments. Perhaps the earliest such technique is the Watermark. In this approach, a latent image is provided on a paper substrate such that the image is invisible when the paper is viewed in reflection, but visible when it is viewed in transmission.

A more recent means of concealing images for security applications is known broadly as “Modulated Digital Images” (MDI). As noted by Amidror (Issac Amidror, “The Theory of the Moiré Phenomenon”, Kluwer Academic Publishers, Dordrecht, 2000, pages 185-187), when two locally periodic structures of identical periodicity are superimposed upon each other, the microstructure of the resulting image may be altered (without generation of a formal Moiré pattern) in areas where the two periodic structures display an angle difference of α=0°. The extent of the alteration in the microstructure can be used to generate latent images which are clearly visible to an observer only when the locally periodic structures are cooperatively superimposed. This principle forms the basis of several techniques for concealing or encoding latent images by modulating periodic structures. These latent images can only be observed when they are superimposed upon a corresponding, non-modulated structure. Accordingly, a modulated image can be incorporated in an original document and a decoding screen corresponding to the non-modulated structure used to check that the document is an original—e.g. by overlaying a modulated image with a non-modulated decoding screen to reveal the latent image.

While such techniques are themselves useful, where the presence of such images can be detected, there is a risk that malicious parties will develop techniques for decoding such images or replicating them. Accordingly, it would be desirable to provide a technique which is suitable for concealing at least modulated digital images and preferably other image types as well.

### SUMMARY OF THE INVENTION

The invention provides a method of forming a security image from two or more images comprising:

manipulating tonal values of each image element of a first image to take values within a first set of tonal values;

manipulating tonal values of each image element of a second image to take values within a second set of tonal values; and

forming a security image from the manipulated tonal values of the first and second images, the first and second sets of tonal values being selected so that at least one of the first and second images is concealed in the security image.

The tones may be grey scale tones or colour tones.

In one aspect, the invention is used to conceal an encoded image within a visible image. In this embodiment, the first image is a visible image and the second image is an encoded image which can be decoded using a decoding screen, the encoded image being the image concealed in the security image. There many also be additional visible or encoded images.

The encoded image is typically a digitally modulated image.

The method may involve converting a latent image to obtain an encoded image.

In this embodiment, it is preferred that the first set of tonal values is larger than the second set of tonal values. Preferably the ratio of the first set of tonal values to the second set of tonal values is in the range of 55:45 to 80:20 and more preferably in the range 60:40 to 70:30.

It is preferred that the sum of the number of tones in the first and second sets is equal to the number of available tones for the image representation technique.

In one embodiment, each of the first and second sets of tonal values are ranges of sizes whose sum is equal to the number of available tones in the range of tones for the image representation technique. In this embodiment it is preferred that each of the first and second images are full tone range images and that each of the first and second images are manipulated by proportionally compressing the values of the tones to take values within the first and second ranges. The image may then be formed by adding the tonal values of corresponding image elements. These combined image elements take values within the full tonal range. By way of example, where the original tonal range is 0-255 of grey-scale tones, the first image may be compressed to 0-179 and the second image may be compressed to 0-76. The added tonal values are added to take values between 0-255.

In another aspect, the invention is used to conceal a plurality of images within a security image in such a manner that they can each be decoded by a processing means.

This embodiment is particularly suited to combining a plurality of two tone images including at least first image and second image, by allocating each image element of each two tone image one of the values of the bit, and

wherein the security image is formed by adding the values of the respective bits to obtain a grey scale value for each image elements.

Thus, in this embodiment, segments (e.g. bits) of a code for defining the tonal value (e.g. a grey scale value) of each image element are allocated as the sets of tonal values for respective ones of the plurality of images so that the segments can be combined to form a composite tonal value of each image element without disturbing the values of the segments so they, and hence the plurality of images, can be decoded.

The invention also extends to security devices incorporating security images made in accordance with the above methods.

Such security devices may be stand alone devices or may be incorporated as parts of documents, instruments etc.—for example, they may be used in passports, security cards, credit cards and bank notes.

Accordingly, the invention provides a security device comprising:

a security image formed from manipulated tonal values of first and second images, the first and second images being manipulated to take values within the first and second sets of tonal values, the sets of tonal values being selected so that at least one of the first and second images is concealed in the security image.

The term “security image” is used to refer to an image which contains one or more concealed images. It will be appreciated that the concealed image teed only be in a portion of the area of the security image. As tones are manipulated to conceal the images, these security images are also referred to as “Tonagrams”.

In this specification, “Image elements” refer to image portions which are manipulated collectively. Typically, these will be pixels, however, they may be groups of pixels (e.g. a 2×2 matrix of pixels), depending on the desired resolution and reproduction technique.

In this specification, any image or images used in the formation of a security image which are intended to be readily apparent to an observer in a finished security image are referred to as “visible images”.

Similarly, images used in the formation of a security device which are to be encoded and hidden in the security image are referred to as “latent images”—the latent images are intended to be visible once decoded.

Once the latent images have been encoded, for example using a MDI algorithm such as that employed to make a Phasegram, Binagram or μ-SAM, the images are referred to in this specification as “encoded latent images” or “encoded images”.

Once visible images are manipulated to take values within a set of tonal values different to those used to initially represent the visible images they are referred to in this specification as “tonal visible images”.

Similarly, when the tonal range of encoded latent images have been manipulated, the resulting images are referred to as “tonal encoded latent images” or “tonal encoded images”.

However, it will be appreciated that these tonal images do not necessarily have to be produced and that the security image can be formed directly from the tonal values.

“Concealed images” are the latent images which have been hidden and cannot be observed without a decoding operation. Typically, the concealed image will be an encoded image and the decoding operation will be overlaying the security image with a decoding screen.

Further features of the invention will become apparent from the following description of preferred embodiments of the invention.

### BRIEF DESCRIPTION OF THE DRAWINGS

Preferred embodiments of the invention will be described with reference to the accompanying drawings:

FIG. 1 depicts a visible grey scale image of the first embodiment of the invention in a full tonal range of 0-255 tones,

FIG. 2 depicts a black and white BinaGram of the latent image of the first embodiment of the invention covering the full tonal range of 0-255 tones,

FIG. 3 depicts the appropriate MDI screen which reveals the latent image when overlaid upon FIG. 2,

FIG. 4 depicts FIG. 1 restricted to the tonal range 0-179 (that is, the compressed image V1)

FIG. 5 depicts FIG. 2 restricted to the tonal range 0-76 (that is, the compressed image H1),

FIG. 6 depicts the additive combination of FIG. 4 and FIG. 5. The resulting Tonagram T1 contains the full tonal range of 0-255 tones,

FIG. 7 depicts the image observed when the MDI screen in FIG. 3 is overlaid upon FIG. 6.

FIG. 8 depicts a colour picture containing 256 tones of three primary colours (providing approximately 16 million colour combinations). This is the visible image of the second example of the first embodiment of the invention,

FIG. 9 depicts the resulting Tonagram combination of FIG. 8 and FIG. 3 in the ratio 60%:40% respectively,

FIG. 10 depicts the Tonagram of FIG. 9 partially overlayed with the screen in FIG. 3,

FIG. 11 depicts a Tonagram consisting of a black-and-white visible image combined with an identical, but coloured MDI Binagram,

FIG. 12 depicts the Tonagran in FIG. 11 partially overlaid with the MDI screen in FIG. 3,

FIG. 13 is a schematic depicting the process of forming a Tonagram containing several images and the method of extracting one of the images from the Tonagram.

### DESCRIPTION OF THE PREFERRED EMBODIMENTS

### First Embodiment

Any digital system employed to depict continuous tone images has to reduce the number of shade levels to a discrete number. This applies to both grey scale and colour images. According to one standard (8 bit), the range of shades employed is 256, numbered from 0 to 255 and defined as levels of light output from a computer monitor. Hence in a grey scale depiction, 255 is white and 0 is black. Using the red-green-blue (RGB) colour system, (255R, 255G, 255B) is white and (0R, 0G, 0B) is black (i.e. there are 8 bits for each of red, green, and blue). Other standards incorporate 65,536 tones (at least for grey; 16 bit standards) and 4096 tones (12 bit standard). Similar standards are used for other colour separation techniques such as CYMK.

The central principle of the first embodiment of the present invention is to form a security image which unobtrusively combines one or more visible images with one or more concealed latent images by partitioning each of the visible and latent images into selected tonal ranges and then combining them into a single security image using a suitable algorithm. The effect of reconstituting an image into a reduced tonal range is to lessen the colour range or contrast visible in the image. The image therefore adopts an increasingly “washed-out” appearance as its tonal range is decreased. An image partitioned into a wide tonal range will therefore be more clearly visible and distinct than one constituted within a narrow tonal range. Thus, when a visible image, portrayed in a relatively wide tonal range, is combined with a latent image encoded using a modulated digital image (MDI) technique and portrayed in a narrower tonal range, the latter may become exceedingly difficult to see against the more clearly distinct background of the former. This concealment is amplified by the nature of most MDI encoded latent images, which typically have a uniformly grey or intermediate colour appearance. When the security image is overlaid with the appropriate MDI decoding screen however, the latent image is revealed as a result of the selective silhouette produced by the screen. In this way it becomes possible to conceal latent images incorporated within clearly visible images.

To most successfully implement this technique, a choice is required in the tonal ranges employed for the visible and the latent image. In order to make the visible image highly obvious, a large tonal range is desirable. The same is true for the latent image, which is ideally also constructed with a large tonal range. However, the latent image is more effectively concealed against the background of the visible image, when the tonal range of the visible image is large relative to that of the latent image.

In order to maximise the contrast and visibility of both the visible image (under ambient conditions) and the latent image (when overlaid with a screen), a large tonal range is required. A security device having a security image of this type will consequently typically employ the full tonal range available for the method of display or reproduction employed. Since a limited tonal range exists for any one method of displaying an image, a complementarity in the tonal ranges of the visible and the latent image must occur in such a case. That is to say, if the entire tonal range is cumulatively employed, then increasing the tonal range of the visible image means that the tonal range of the latent image must decrease correspondingly. The cumulative number be tonal ranges present in the tonal visible images and the tonal concealed latent images may not exceed the maximum number of tones available in the method of image representation employed. In the optimal case, the tonal range used for the visible image will be large enough (both in absolute terms and relative to the tonal range of the latent image) to make the visible image highly obvious under ambient conditions while simultaneously concealing the latent image effectively. However, the tonal range of the visible image must not be so large as to cause the latent image to have so narrow a tonal range as to be indistinguishable when overlaid with the appropriate MDI screen. An effective device therefore requires a careful balance in the competing requirements of clear visibility of, the latent image when overlaid with an appropriate MDI screen, but clear concealment against the background of the visible image in the absence of the MDI screen.

There are a number of MDI techniques which can be used with the present invention. One such technique, known as Screen Angle Modulation, “SAM”, or its micro-equivalent, “μ-SAM”, is described in detail in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199), both incorporated herein by reference. In this technique, latent images are created within a pattern of periodically arranged, miniature short-line segments by modulating their angles relative to each other, either continuously or in a clipped fashion. While the pattern appears as a uniformly intermediate colour or grey-scale when viewed macroscopically, a latent image is observed when it is overlaid with an identical, non-modulated pattern on a transparent substrate.

We have developed another technique of this type which we refer to as a PHASEGRAM described in Australian provisional application number 2003905861, entitled “Method of Encoding a Latent Image”, filed 24 Oct. 2003, and also disclosed in PCT/AU2004/000915 filed 7 Jul. 2004, the disclosure of which is incorporated herein by reference. In this technique, an image is encoded within a locally periodic pattern by selectively modulating the periodicity of the pattern. When overlaid upon or overlaid by the original pattern on a transparent substrate, the latent image or various shades of its negative becomes visible to an observer depending on the exactness of the registration.

We have also developed a further technique of this type which we refer to as a BINAGRAM which is disclosed in Australian provisional application number 2003902810, entitled “Method of Encoding a Latent Image”, filed 4 Jun. 2003, and also disclosed in PCT/AU2004/00746 filed 4 Jun. 2004, the disclosure of which is incorporated herein by reference. In this technique, an image is divided into pairs of adjacent or nearby pixels, which may be locally periodic or not. One of the pixels in each pair is then selectively modulated to the complementary grey-scale or colour characteristic of the other pixel. Because of the presence of equal quantities of complementary pixels, a BINAGRAM has a uniform grey- or intermediate tone when viewed macroscopically. However, when overlaid upon or overlaid with an equivalent non-modulated pattern on a transparent substrate, the latent image or its negative becomes visible depending on the extent of registration.

The technique of the first embodiment is now explained further using a series of examples. In each example, a single visible image is combined with a single encoded latent image. The preferred embodiment can be applied to a variety of encoded latent image types. Without limiting the generality of this embodiment, a Binagram MDI image is employed for illustrative purposes in the examples of the embodiment described below. A Binagram contains, by definition, only 2 tones; usually black and white.

Further details on producing a Binagram can be found in International patent application number PCT/AU2004/000746 entitled: “method of Encoding a Latent Image”, lodged 4 Jun. 2004. Details of other techniques such as μ-SAM, and PEASEGRAM can be found in U.S. Pat. No. 5,374,976 and International patent application PCT/AU2004/000915 entitled “Method of Encoding a Latent Image”, patent application number: 2003905861 (24 Oct. 2003) respectively.

The first example of this embodiment describes the use of a black-and-white visible image and a black-and-white latent image. For this example the full tonal range will be considered to be 0-255 in a grey scale for illustrative purposes. The range 0-179 will be used for the visible image. This leaves the range 0-76 for the latent image (since 179+76=255). These ranges have been chosen merely to demonstrate the technique. Optimisation of the resulting security image will, as noted earlier in this specification, typically involve iteratively varying the respective tonal ranges used for the visible and latent image in order to achieve the best overall effect.

The ranges selected for this example correspond to approximately 70% of the total tonal range for the visible image and 30% for the hidden image. These proportions while effective for many images, can be varied to suit the images employed, the number of images and the application.

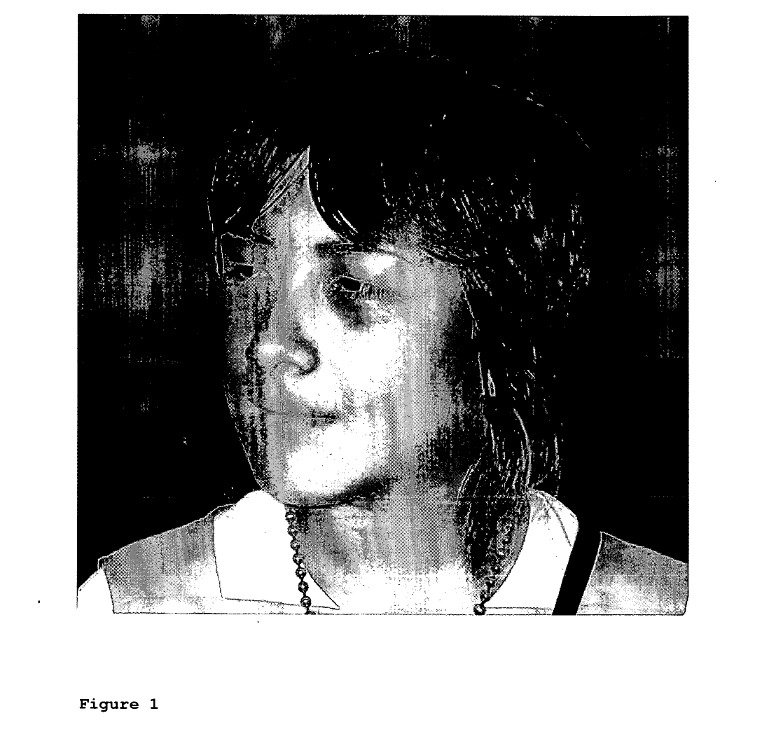

The visible image shown in FIG. 1 is manipulated by being compressed from 0-255 tones to 0-179 tones using the contrast and brightness controls in a typical image processing software package, of specialised software developed for the purpose or photographically or other means known to the art. The manipulated tone value of each pixel of the original visible image (T_{OLD}^{vis}) then becomes a new tone value (T_{NEW}^{vis}):
T_{NEW}^{vis}=T_{OLD}^{vis}×179/255

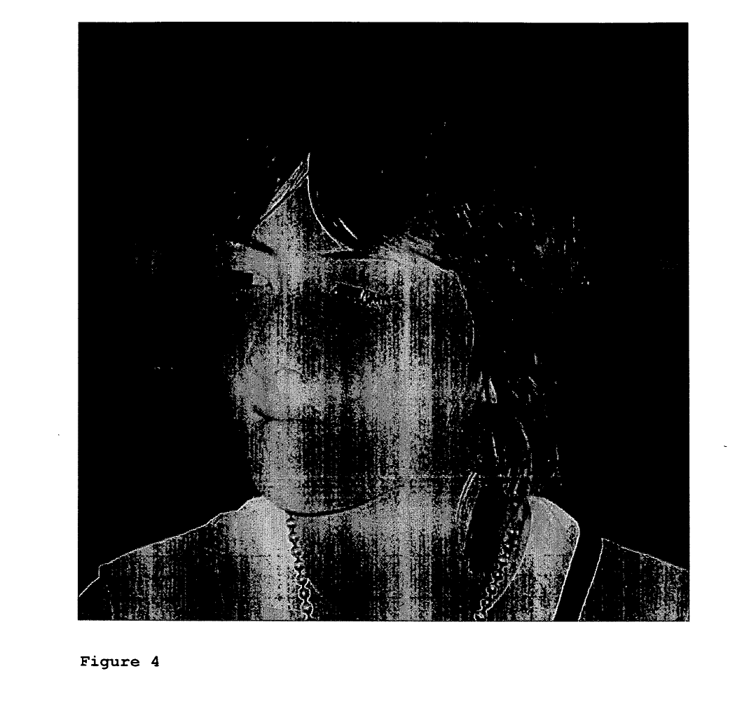

The resulting tonal visible image is called V1 and is shown in FIG. 4. While the compression is performed proportionally in this particular case, other techniques can be used. Other mathematical relationships could be employed to compress the tonal ranges of both images, for example in conjunction with a mathematical relationship to combine the images depending on the application. Such relationships may provide added advantages in particular applications.

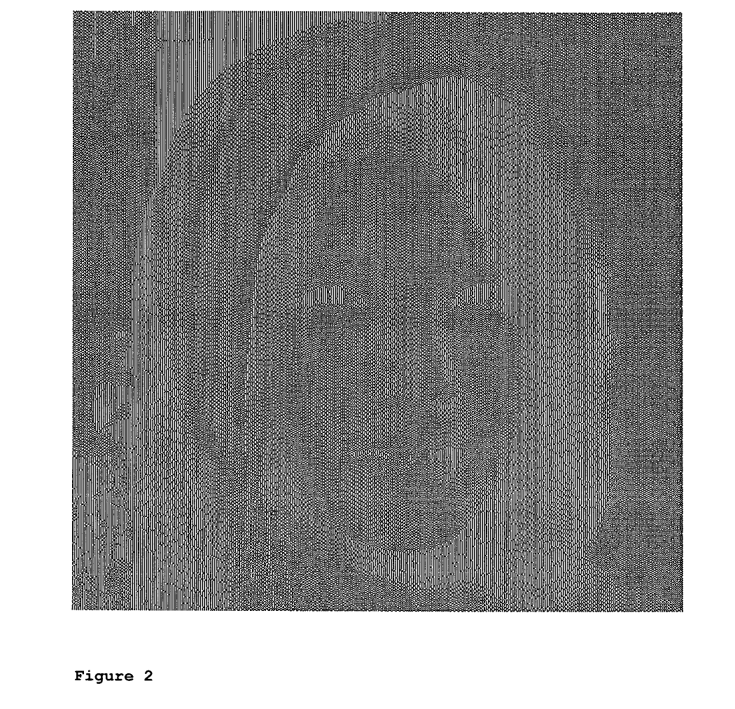

The encoded latent image of FIG. 2 is manipulated by being compressed from 0-255 tones to 0-76 using the contrast and brightness controls in a typical image processing software package, or specialised software developed for the purpose or photographically or other means known to the art. For this example the tone in each pixel of the original latent image (T_{NEW}^{lat}) becomes replaced by a new tone (T_{OLD}^{lat}) calculated by the formula:
T_{NEW}^{lat}=T_{OLD}^{lat}×76/255

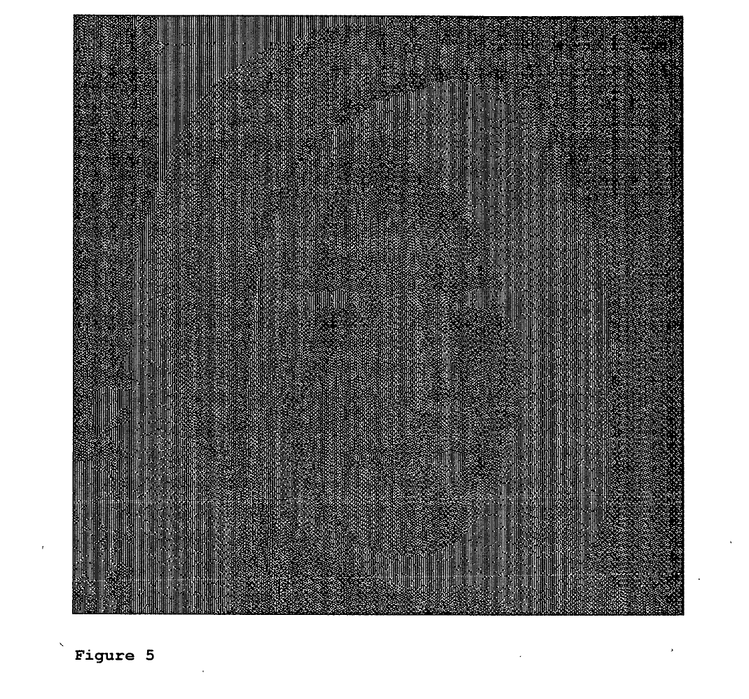

The resulting tonal encoded image is called H1 and is depicted in FIG. 5,

The images are now summed tonally into a security image. This means that wherever two pixels T_{NEW}^{lat} and T_{NEW}^{vis} overlap, they are combined into a new pixel having the tone T_{TON}, where
T_{TON}=T_{NEW}^{lat}+T_{NEW}^{vis}

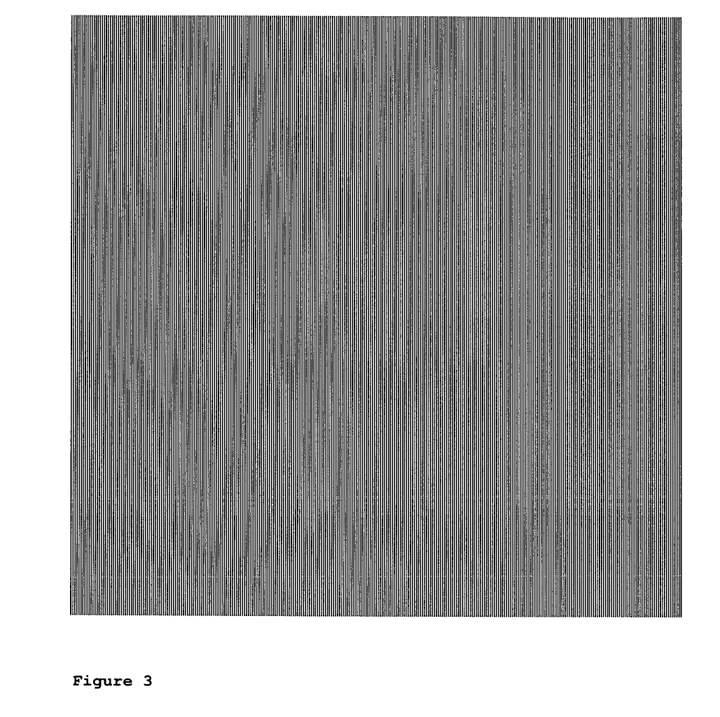

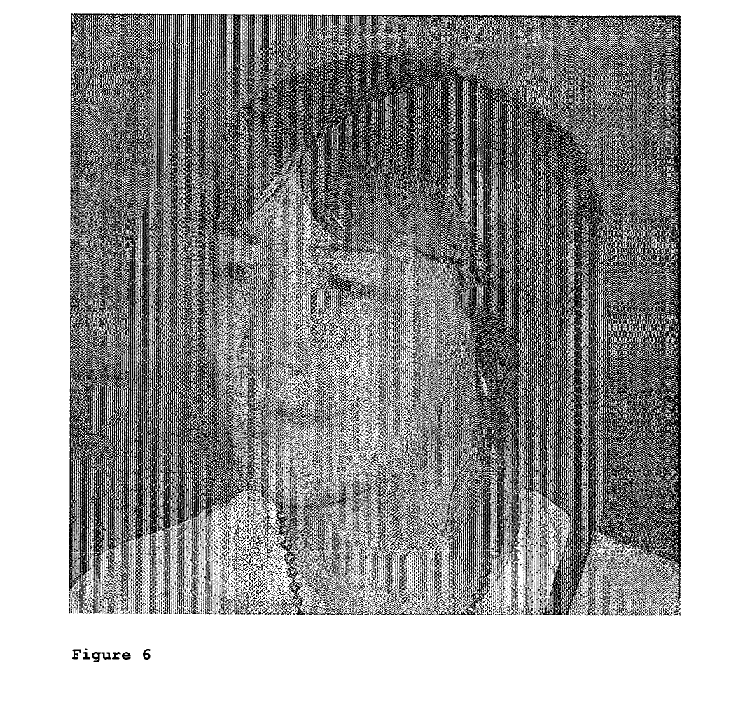

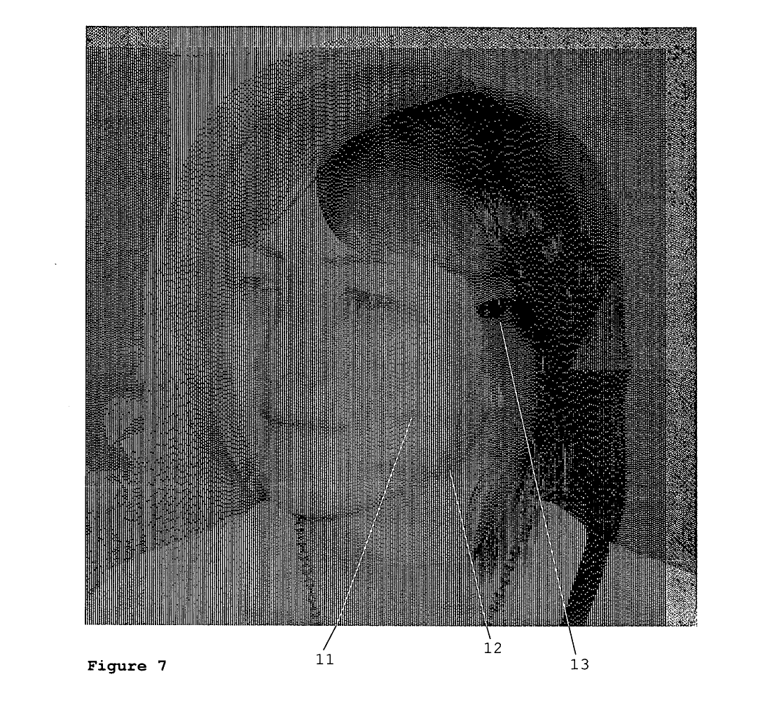

The resulting security image is the Tonagram, T1, which is shown in FIG. 6. When overlaid with the appropriate MDI mask (FIG. 3), the latent image is revealed superimposed upon the visible image (FIG. 7)—i.e. the mask decodes the latent image sufficiently for the existence of the latent image to be perceived. For example, the nose 11, mouth 12, and left eye 13 of the girl in the latent image are now perceivable.

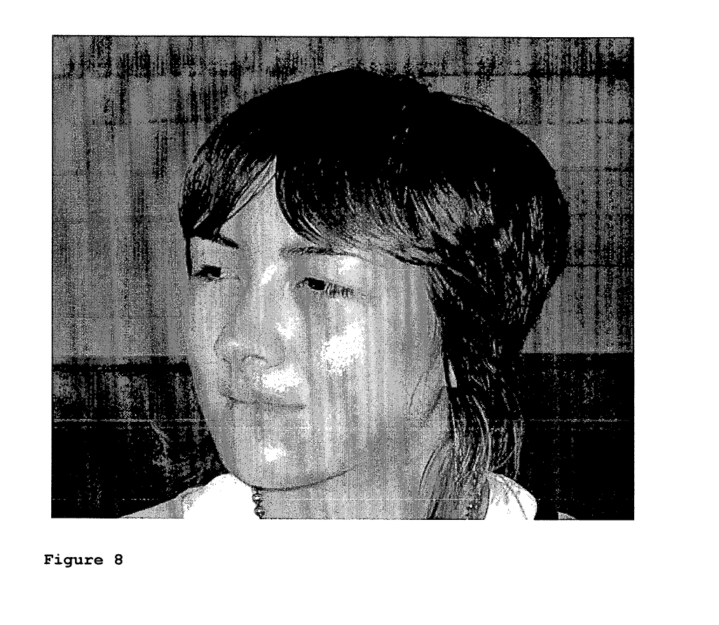

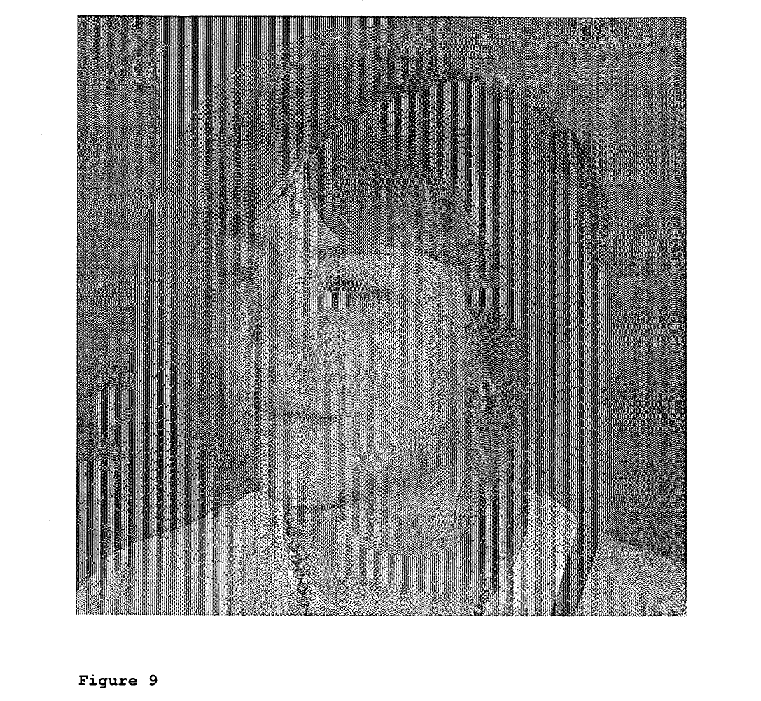

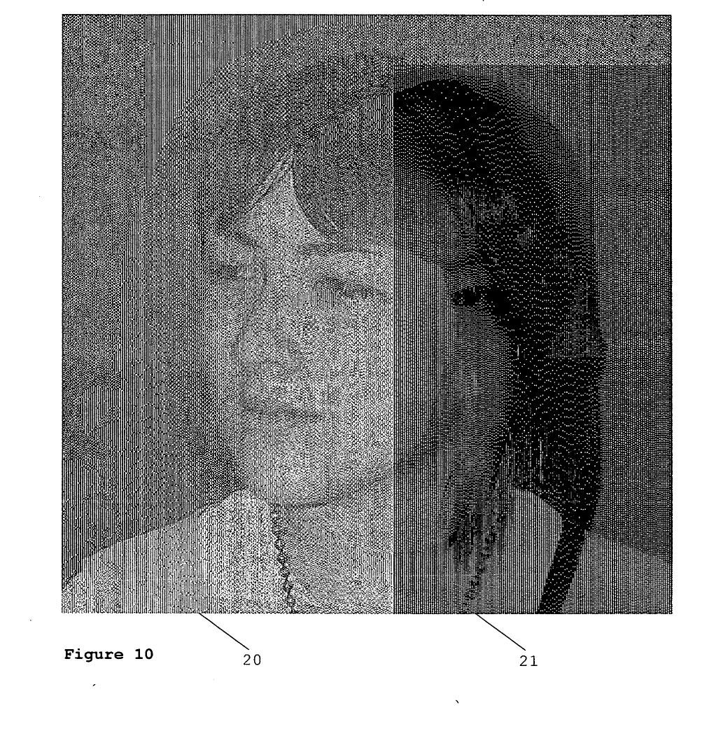

The second example of this embodiment describes the use of a colour visible image and a black-and-white latent image. A colour image reproduced as a grey scale image in FIG. 8 was employed as the visible image and the binagram shown in FIG. 2 was used for the encoded latent image. In this example the three primary colours (red, green, blue) were scaled to 60% of the full tonal range (tones 0-153) and the latent image was scaled to 40% of the full tonal range (tones 0-101). The tonal visible image and tonal encoded latent image were then additively combined to give FIG. 9. It will be appreciated that the use of colour tends to draw the observer's eye away from the “shadow” left by the encoded image. FIG. 10 illustrates this Tonagram with a partial overlay of the MDI screen in FIG. 3. The unscreened area 20 has a shadow whereas, in the screened area 21, the girl is visible. The latent image is thus made visible as a black and white image superimposed on the colour image.

Colour binagrams can similarly be combined with grey scale or coloured images.

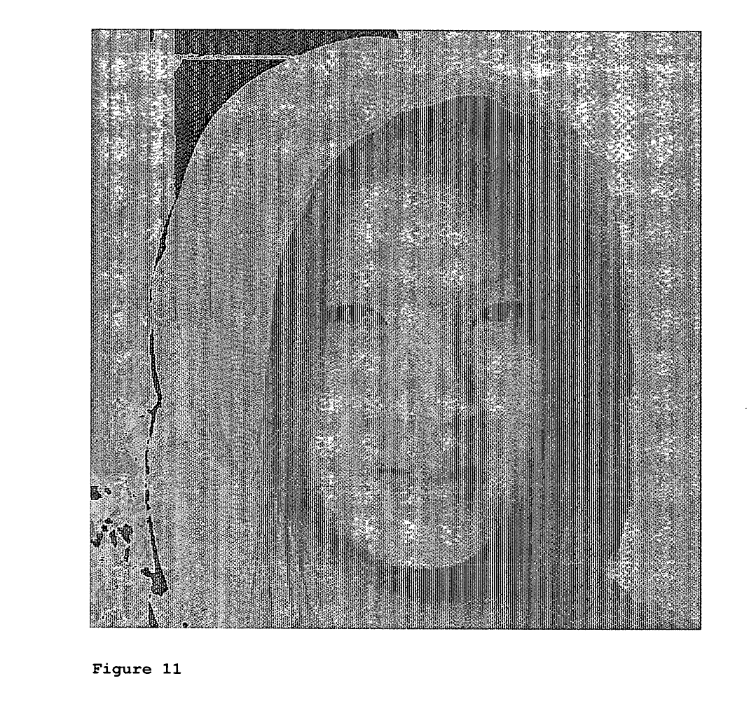

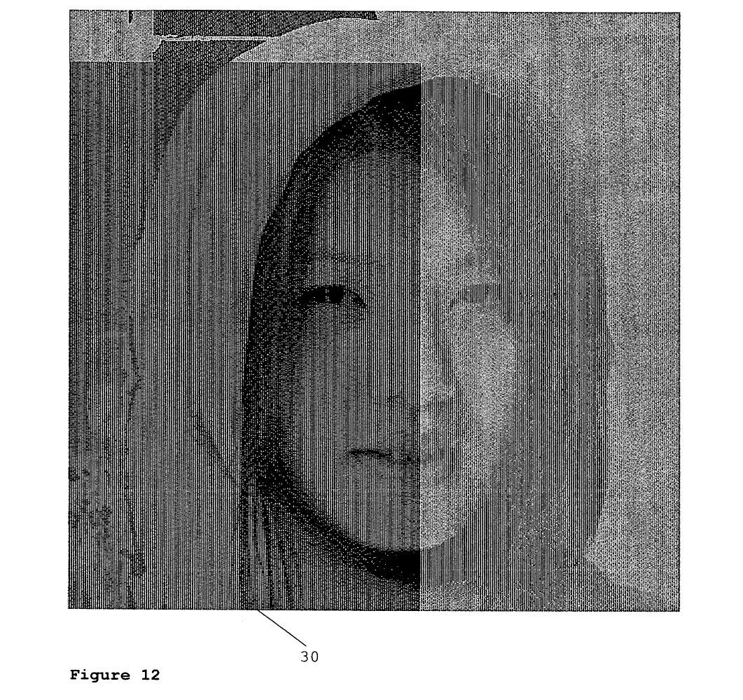

In a third example of this embodiment, a black-and-white visible image is combined with an identical, colour MDI latent image using the method of the second example of this embodiment above. The resulting Tonagram is shown in FIG. 11. The latent image is not visible because it is identical to the visible image. However when the Tonagram in FIG. 11 is overlaid with the MDI screen in FIG. 3, the colour image in the screened areas 30 is revealed. Thus, the black-and-white visible image becomes a coloured image when overlaid with the screen. This is depicted in FIG. 12.

In an alternative approach, the sets of tonal value may be kept distinct—e.g. 0-179 and 180-255 with the security image being formed by interleaving image elements having manipulated tonal values originating from the first and second images respectively. In this approach, sets could also be in the form of a plurality of distinct ranges—e.g. 0-80, 125-224 and 81-124, 225-255—this allows a greater degree of contrast to be achieved in the visible image.

### Second Embodiment

A Tonagram may encode and conceal more than one continuous tone image. Separation of the latent images from the security image however requires electronic or mathematical computations based on a suitable algorithm, with the resulting security images decoded by a computer or dedicated device developed for the purpose, rather than using an overlaid screen.

If the display technology employed permits a number of hues or primary colours, each with a tone range, then each hue can be used independently to contain a single grey scale continuous tone image in conjunction with other 2-tone latent images or a multiple of 2-tone images.

The 2-tone latent images may be produced by dithering, half-toning, hatching or using some other means by which an image is rendered in two tones. Even dithered coloured images may be adapted to this embodiment. Modulated digital images and other synergistic latent images like Binagrams and Phasegrams are two tones per hue and are readily integrated to form multiple latent image Tonagrams.

One way in which a multiple latent image Tonagram employing a machine-based encoding/decoding system may operate is illustrated in the following example in which an 8-bit binary code is used to address each pixel. Other multi-bit systems (e.g. 16-bit, 24-bit, or 32-bit, etc.) may also be used. The following example demonstrates the use of a single binary bit or digit to contain each image. Other carefully chosen multiple bit codes could be used and even the use of non-binary sequences is possible. The sequences need to be chosen so that information is not altered when the sequences are combined so that the information can subsequently be decoded from the security image.

A typical computer monitor uses an 8-bit binary code to describe the tone of each pixel on the screen. Such a code contains 8 numbers, each of which can only be a 0 or a 1. For example, if a pixel has a tone 11110110, this means it contains (1×2⁷)+(1×2⁶)+(1×2⁵)+(1×2⁴)+(0×2³)+(1×2²)+(1×2¹)+(0×2⁰). In decimal notation, this equals tone number 246. Using an 8-bit binary code therefore, pixel tones can go from 00000000 (which corresponds to decimal tone 0) to 11111111 (which corresponds to decimal tone 255). Thus, a computer monitor operating using 8-bit binary coding for the tones can display 256 different tones.

This system can be exploited by partitioning each image in a multiple image Tonagram so that it is described by only one of the bits in the 8-bit code. For example, a 2-tone image in an 8-image Tonagram may be compressed so that all of its pixels are associated with only the first numeral in the code; that is, all of its pixels are either 00000000 (darker of the 2-tones) or 00000001 (lighter of the 2-tones). This is possible since the image contains only two tones. A second 2-tone image may be compressed such that all of its pixels are associated only with the second digit in the 8-bit binary code; that is they are either 00000000 (darker tone) or 00000010 (lighter tone). A third 2-tone image may be compressed such that all of its pixels are associated with only the third digit in the code; that is all of its pixels are either 00000000 (darker tone) or 00000100 (lighter tone). This can be done for each of eight 2-tone images, up to the eighth image, whose pixels will be either 00000000 (darker tone) or 10000000 (lighter tone).

To achieve this, the image elements of the first latent image must be manipulated to the tonal range of the first bit. The second latent image must be compressed to the tonal range of the second bit. The third latent image must be compressed to the tonal range of the third bit. The fourth latent image must be compressed to the tonal range of the fourth bit. The fifth latent image must be compressed to the tonal range of the fifth bit. The sixth latent image must be compressed to the tonal range of the sixth bit. The seventh latent image must be compressed to the tonal range of the seventh bit. The eighth latent image must be compressed to the tonal range of the eighth bit.

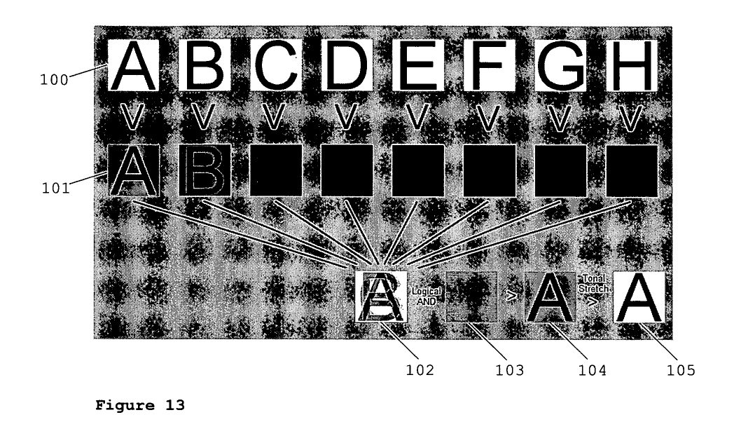

The top row 100 of FIG. 13 displays eight 2-tone latent images. The next row 101 down in FIG. 13 shows each of the images compressed to the above tonal ranges, with the left most image compressed to the eighth (or left most) bit, the second from left to the seventh bit, and so on up to the right most latent image which is compressed to the first (or right most) bit.

When the latent images are now overlaid, their individual pixels will overlap each other. To combine the 8 images into a single image, the binary codes of overlapping pixels are added. As the binary code of each pixel to be combined has either a 0 or a 1 in a unique position and 0's in all other positions, the resulting sum will have 0's and 1's whose position corresponds to their image number. For example, if the overlapping pixels of the eight images are:

00000001 (first image)
00000010 (second image)
00000000 (third image)
00001000 (fourth image)
00010000 (fifth image)
00000000 (sixth image)
01000000 (seventh image)
00000000 (eighth image)

then the sum will be:
01011011

This signifies that the corresponding pixel in the first, second, fourth, fifth and seventh image has the lighter of its 2-tones present (“1”). However the corresponding pixels in images 3, 6, and 8 have the darker of their 2-tones present.

Each pixel in the resulting 8-image Tonagram will consequently have such an 8-bit binary code in which the corresponding pixel in each of the constituent images is shown to be darker (“0”) or lighter (“1”), depending on its position in the code.

The left most image 102 on the bottom row of FIG. 13 displays the 8-image Tonagram of the images shown at the top of that Figure. As can be seen, most of the latent images within the Tonagram are well concealed. In this respect, it will be appreciated that the Tonagram of this embodiment does not employ a visible image.

Any of the individual images making up the 8-image Tonagram can be readily extracted and reconstituted using the logical “and” command. When two binary codes are subjected to the “and” command, they are combined using the following rules for each corresponding pair of binary digits:
0+0=0
0+1=0
1+0=0
1+1=1

Thus, if one wishes to extract the sixth image from the 8-image Tonagram, then all pixels of the Tonagram are mathematically subjected to an “and” operation with the code 00100000. This has the effect of forcing all of the digits in the answer to become 0's, except for the digit in the sixth position, which becomes “1” if a “1” existed in that position in the Tonagram pixel, or “0” if at “0” existed in that position in the Tonagram pixel. By this means the tones for the sixth image at each pixel is extracted.

The process shown to the right of the 8-image Tonagram in FIG. 13 involves a logical and operation with a screen 103 consisting entirely of pixels having the code 10000000. As can be seen in the resulting image 104 (second from the right on the bottom line of FIG. 13), this results in extraction of the left most of the original images (top line of FIG. 13), albeit in tonally compressed form. In the final process shown on the right of the bottom line in FIG. 13, the extracted image 105 is now decompressed (that is, is stretched into the full tonal range), returning the original image at the top left of FIG. 13.

It will be apparent to persons skilled in the art that further variations on the disclosed embodiments fall within the scope of the invention.

1. A method of forming a security image from two or more images comprising:
manipulating tonal values of each image element of a first image to take values within a first set of tonal values;
manipulating tonal values of each image element of a second image to take values within a second set of tonal values; and
forming a security image from the manipulated tonal values of the first and second images, the first and second sets of tonal values being selected so that at least one of the first and second images is concealed in the security image.

2. A method as claimed in claim 1 comprising selecting the first image to be a visible image and selecting the second image to be an encoded image which can be decoded using a decoding screen so that the encoded image is the image concealed in the security image.

3. A method as claimed in claim 2 further comprising:
manipulating tonal values of each image element of at least one additional image to take values within an additional set of tonal values; and
forming the security image from the manipulated tonal values of the first, second and at least one additional images.

4-5. (canceled)

6. A method as claimed in claim 2, wherein the encoded image is selected to be a digitally modulated image.

7. (canceled)

8. A method as claimed in claim 2 wherein the first set of tonal values is selected to be larger than the second set of tonal values.

9-10. (canceled)

11. A method as claimed in claim 1 wherein the number of tones in the first and second sets is equal to the number of available tones for the image representation technique.

12. A method as claimed in claim 11 wherein each of the first and second sets of tonal values are ranges of consecutive tones, the sum of the ranges being equal to the number of available tones in the range of tones for the image representation technique.

13. (canceled)

14. A method as claimed in claim 12, wherein the first and second images are full tone range images and each of the first and second images are manipulated by proportionally compressing the values of the tones to take values within the first and second ranges.

15-16. (canceled)

17. A method as claimed in claim 1 comprising concealing a plurality of images within the security image in such a manner that they can each be decoded by a processing means.

18. A method as claimed in claim 17 comprising combining a plurality of two tone images including at least said first image and said second image, and manipulating each image element of each two tone image to take one of the values of a bit, and
forming the security image by adding the values of the respective bits to obtain a grey scale value for each image elements.

19. A method as claimed in claim 17 comprising allocating segments of a code for defining the tonal value of each image element of the security image as the sets of tonal values for respective ones of the plurality of images so that the segments can be combined to form a composite tonal value of each image element without disturbing the values of the segments so they, and hence the plurality of images, can be decoded.

20-21. (canceled)

22. A security device comprising:
a security image formed from manipulated tonal values of first and second images, the first and second images being manipulated to take values within the first and second sets of tonal values, the sets of tonal values being selected so that at least one of the first and second images is concealed in the security image.

23. A security device as claimed in claim 22 wherein the first image is a visible image and the second image is an encoded image which can be decoded using a decoding screen so that the encoded image is the image concealed in the security image.

24. A security device as claimed in claim 23 wherein the encoded image is a digitally modulated image.

25. A security device as claimed in claim 22 wherein the first set of tonal values is larger than the second set of tonal values.

26-27. (canceled)

28. A security device as claimed in claim 22 wherein the number of tones in the first and second sets is equal to the number of available tones for the image representation technique.

29. A security device as claimed in claim 28 wherein each of the first and second sets of tonal values are ranges of consecutive tones, the sum of the ranges being equal to the number of available tones in the range of tones for the image representation technique.

30. A security device as claimed in claim 28 wherein at least one of the first and second sets of tonal values comprises two or more ranges of consecutive tones.

31-33. (canceled)

34. A security device as claimed in claim 33 wherein a plurality of two tone images including at least said first image and said second image are combined and manipulated by allocating each image element of each two tone image one of the values of a bit, and
the security image is formed by adding the values of the respective bits to obtain a grey scale value for each image elements.

35. A security device as claimed in claim 34 wherein segments of a code for defining the tonal value of each image element of the security image are allocated as the sets of tonal values for respective ones of the plurality of images so that the segments can be combined to form a composite tonal value of each image element without disturbing the values of the segments so they, and hence the plurality of images, can be decoded.

36-37. (canceled)
